(19) United States
(12) Patent Application Publication
(10) Pub. No.: US 2021/0150655 A1
(43) Pub. Date: May 20, 2021

(54) INFORMATION PROCESSING APPARATUS, INFORMATION PROCESSING METHOD AND STORING MEDIUM

(71) Applicant: Toyota Jidosha Kabushiki Kaisha, Toyota-shi Aichi-ken (JP)

(72) Inventors: Shintaro Matsutani, Kariya-shi (JP); Aya Sato, Miyoshi-shi (JP); Yasuki Nakagawa, Toyota-shi (JP); Shigeru Inamori, Nagoya-shi (JP); Fuminori Matsuoka, Toyota-shi (JP); Taro Hasegawa, Toyota-shi (JP); Masaki Nanahara, Toyota-shi (JP); Misaki Sato, Nisshin-shi (JP); Motoki Maekawa, Nagakute-shi (JP); Hiroki Ashizawa, Toyota-shi (JP)

(21) Appl. No.: 16/951,206

(22) Filed: Nov. 18, 2020

(30) Foreign Application Priority Data
Nov. 20, 2019 (JP) 2019-209466

(51) Int. Cl. G06Q 50/28; G06Q 10/06; G07C 9/00; G05B 19/4155; B60P 1/64

(52) U.S. Cl. CPC G06Q 50/28; G06Q 10/06315; G07C 9/00896; G05B 2219/32029; G05B 19/4155; B60P 1/6481; G07C 2009/0092; G07C 9/00182

(57) ABSTRACT

An information processing apparatus includes a controller configured to acquire package information, which is information on a size of one or more packages to be transported, select, based on the package information, a storage apparatus to be loaded on a vehicle from among a plurality of storage apparatuses having different characteristics that is capable of containing the one or more packages in a plurality of compartments that is capable of being independently locked, and generate a command to load the selected storage apparatus on the vehicle.

### CROSS REFERENCE TO RELATED APPLICATION

This application claims priority to Japanese Patent Application No. 2019-209466, filed on Nov. 20, 2019, incorporated herein by reference in its entirety.

### BACKGROUND

### Technical Field

The present disclosure relates to a technique of providing a delivery service by vehicle.

### Description of the Related Art

Attempts have been made to provide services by sending autonomous cars designed for various purposes. For example, Patent document 1 discloses an apparatus that determines a vehicle to be sent based on the demand for a service and the availability of vehicles and indicates the vehicle to move.

The vehicle is formed by a combination of a vehicle platform (chassis) and a cabin module (cabin), and the cabin can be changed to meet various demands.

### CITATION LIST

Patent Document 1: Japanese Patent Laid-Open No. 2019-075047

### SUMMARY

According to the invention described in Patent document 1, the use of the vehicle can be changed by replacing the cabin loaded on the chassis. For example, if a cabin serving as a parcel locker (Locker for receiving deliveries, installed to in designated locations. Also called a delivery Locker) is loaded, a parcel locker capable of autonomously moving can be realized, so that the efficiency of the package delivery can be improved. However, the packages to be transported vary in size and quantity, and therefore an optimum parcel locker cannot always be selected.

The present disclosure has been devised in view of the problem described above, and an object of the present disclosure is to improve the efficiency of the package delivery.

A first aspect of the present disclosure is an information processing apparatus that generates a command to load a storage apparatus on a vehicle.

Specifically, the information processing apparatus includes a controller configured to acquire package information, which is information on a size of one or more packages to be transported, select, based on the package information, a storage apparatus to be loaded on a vehicle from among a plurality of storage apparatuses having different characteristics that is capable of containing the one or more packages in a plurality of compartments that is capable of being independently locked, and generate a command to load the selected storage apparatus on the vehicle.

A second aspect of the present disclosure is an information processing method performed by the information processing apparatus described above.

Specifically, the information processing method includes: an acquisition step of acquiring package information, which is information on a size of one or more packages to be transported; a selection step of selecting, based on the package information, a storage apparatus to be loaded on a vehicle from among a plurality of storage apparatuses having different characteristics that is capable of containing the one or more packages in a plurality of compartments that is capable of being independently locked; and a generation step of generating a command to load the selected storage apparatus on the vehicle.

Another aspect is a program that makes a computer perform the information processing method performed by the information processing apparatus described above, or a computer readable memory medium that non-temporarily stores the program.

According to the present disclosure, an appropriate service can improve the efficiency of the package delivery.

### BRIEF DESCRIPTION OF THE DRAWINGS

FIG. 1 is a diagram illustrating a general configuration of a delivery system according to a first embodiment.

FIG. 2 is a view showing an appearance of a storage apparatus according to the first embodiment.

FIG. 3A is a diagram illustrating an example combination of storage apparatuses loaded on a chassis unit.

FIG. 3B is a diagram illustrating another example combination of storage apparatuses loaded on a chassis unit.

FIG. 3C is a diagram illustrating another example combination of storage apparatuses loaded on a chassis unit.

FIG. 4 is a diagram illustrating a system configuration of a server apparatus.

FIGS. 5A and 5B illustrate an example of data relating to the storage apparatus and the chassis unit.

FIG. 6 is a diagram illustrating a system configuration of the storage apparatus and the chassis unit.

FIG. 7 is a flowchart illustrating a process performed by the server apparatus.

FIG. 8 illustrates an example of package data stored by the server apparatus.

FIG. 9 is a flowchart illustrating processings performed by the server apparatus in Step S13.

FIG. 10 is a flowchart illustrating a process performed by the chassis unit.

### DESCRIPTION OF THE EMBODIMENTS

An information processing apparatus according to an embodiment is an apparatus that selects a storage apparatus for transporting and storing a package and generates a command to load the selected storage apparatus on a vehicle.

The storage apparatus is an apparatus that can store a package in a plurality of compartments that can be independently locked. The storage apparatus is referred to also as a parcel locker or a delivery locker.

The vehicle according to the embodiment is a mobile body (a vehicle platform, which will be referred to also as a chassis unit) provided with a plurality of wheels and a power source. The vehicle has only to be able to run and does not have to have a cabin. The vehicle is configured so that a plurality of storage apparatuses can be loaded thereon. By loading a storage apparatus on the vehicle, a delivery vehicle that transports a package can be assembled. If the storage apparatus containing a package is separated from the vehicle and placed at an arbitrary location, a parcel locker can be provided at the location. This allows both the transportation of a package and the unattended delivery of the package.

The information processing apparatus according to the embodiment is an apparatus that generates a command to assemble such a delivery vehicle.

With the information processing apparatus according to the embodiment, a controller acquires package information, which is information on a size of one or more packages to be transported, and selects, based on the package information, a storage apparatus to be loaded on a vehicle from among a plurality of storage apparatuses having different characteristics. The controller then generates a command to load the selected storage apparatus on the vehicle.

The package information is information concerning the size of the package to be transported and typically includes length, width, height, volume, weight or quantity, for example. However, the package information may include other information. By using the package information, which storage apparatus with what characteristics (such as the number and size of compartments) should be loaded on the vehicle in order to transport a plurality of packages can be determined.

The vehicle may be a vehicle that transports the storage apparatus to a predetermined site at which a recipient picks up a package. The predetermined site is a commercial facility, a convenience store or a railway station, for example. However, the predetermined site may be other sites. The storage apparatus is unloaded from the vehicle and placed at the predetermined site.

The controller may perform the selection on an assumption that a plurality of packages destined for a same site is contained in a same storage apparatus.

The controller may select a storage apparatus capable of containing all of a plurality of packages destined for a same site based on the package information.

A site that is a delivery destination is specified for each of the plurality of packages. Therefore, packages destined for the same site are preferably contained in the same storage apparatus. Furthermore, when selecting a storage apparatus, a storage apparatus that can contain all the packages belonging to the same group is preferably selected.

The information processing apparatus may be characterized by further including a storage unit that stores information indicating a size of the plurality of compartments of the plurality of storage apparatuses.

By grasping the size of the plurality of compartments of the storage apparatuses, which storage apparatus should be selected in order to contain a plurality of packages can be determined.

Furthermore, the controller may select a storage apparatus for each specified site. This allows a parcel locker to be placed at a plurality of sites.

The package information may further include key information for unlocking the plurality of compartments, and the controller may transmit the key information to the storage apparatus.

By transmitting the key information to the storage apparatus, the storage apparatus can authenticate the recipient to allow pickup of the package.

The controller may collect information concerning a status of pickup of a package from the plurality of storage apparatuses.

By referring to the status of pickup of a package, it can be determined when to remove (recover) the storage apparatus.

The controller may further generate a command to unload the storage apparatus from the vehicle at a relevant site.

The command may be transmitted to the vehicle or an apparatus that manages the operation of the vehicle.

In the following, embodiments of the present disclosure will be described. The configurations of the embodiments described below are given for illustrative purposes, and the present disclosure is not limited to the configurations of the embodiments.

### First Embodiment

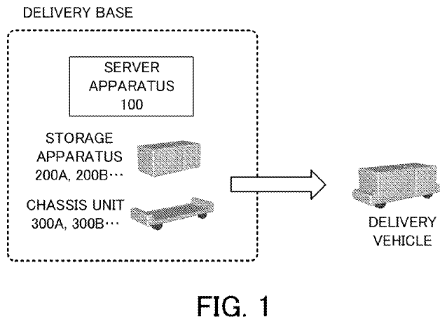

An overview of a delivery system according to a first embodiment will be described with reference to FIG. 1. The delivery system according to this embodiment includes one or more chassis units 300A, 300B and so on that autonomously travel according to a received command, one or more storage apparatuses 200A, 200B and so on loaded on the chassis units, and a server apparatus 100 that issues the command.

In the following, a plurality of chassis units that does not need to be distinguished from one another will be generically referred to simply as a chassis unit 300. A plurality of storage apparatuses that does not need to be distinguished from one another will be generically referred to simply as a storage apparatus 200.

The chassis unit 300 is an automatic vehicle capable of travelling with the storage apparatus 200 loaded thereon. The chassis unit 300 does not need to be an unattended vehicle. For example, a safety attendant can be on the vehicle. The chassis unit 300 may not be a vehicle of totally autonomous operation. For example, the vehicle may be operated or assisted by a person depending on the situation.

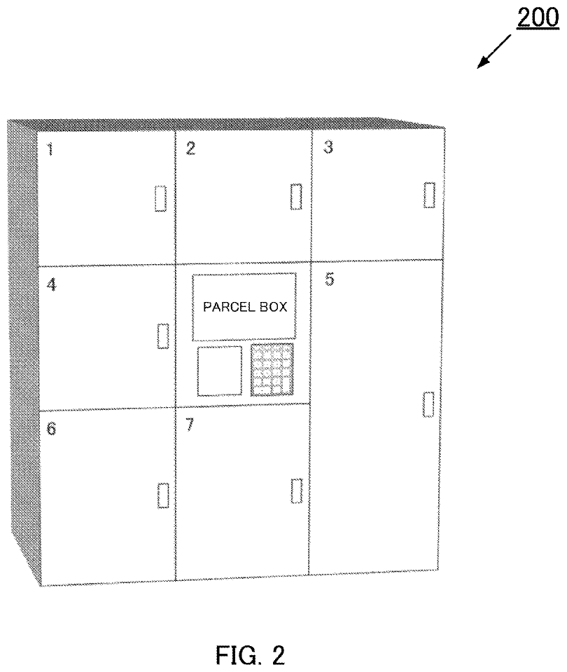

The storage apparatus 200 is a locker-type apparatus (parcel box, delivery locker) that has a plurality of compartments and can contain a package in each compartment. FIG. 2 illustrates an appearance of the storage apparatus 200. As illustrated, the storage apparatus 200 is configured so that each compartment can be accessed by opening a door. A recipient can unlock the specified compartment via an interface provided on the storage apparatus 200.

In this embodiment, at a delivery base (such as a branch office of a delivery company), a plurality of packages is contained in the storage apparatus 200, the storage apparatus 200 is locked, and the storage apparatus 200 containing the plurality of packages is loaded on the chassis unit 300. The chassis unit 300 with the storage apparatus 200 loaded thereon travels to a predetermined location, where the storage apparatus 200 is unloaded and placed. With such a configuration, even a recipient whose house is provided with no parcel box can receive a package using a parcel box.

The location where the storage apparatus 200 is placed is referred to as a pickup site. The pickup site can be set in the premises of a public facility or a commercial facility. In this embodiment, a pickup site is specified for each of the packages to be delivered.

The server apparatus 100 is an apparatus that manages the operation of the chassis unit 300.

As illustrated, the storage apparatus 200 has a plurality of compartments. However, the size of each compartment is fixed, so that packages to be delivered cannot always be contained in one apparatus. For example, if there is a large package, a storage apparatus 200 having a large compartment needs to be selected. If there are many small packages, a storage apparatus 200 having a large number of small compartments needs to be selected.

Furthermore, when delivering packages to two or more pickup sites, two or more storage apparatuses 200 need to be loaded on one chassis unit 300.

To this end, the server apparatus 100 determines the number and types of the storage apparatus 200 to be loaded based on the characteristics of the packages to be transported. With the delivery system according to this embodiment, a predetermined storage apparatus(es) 200 is loaded on the chassis unit 300 according to the determination by the server apparatus 100.

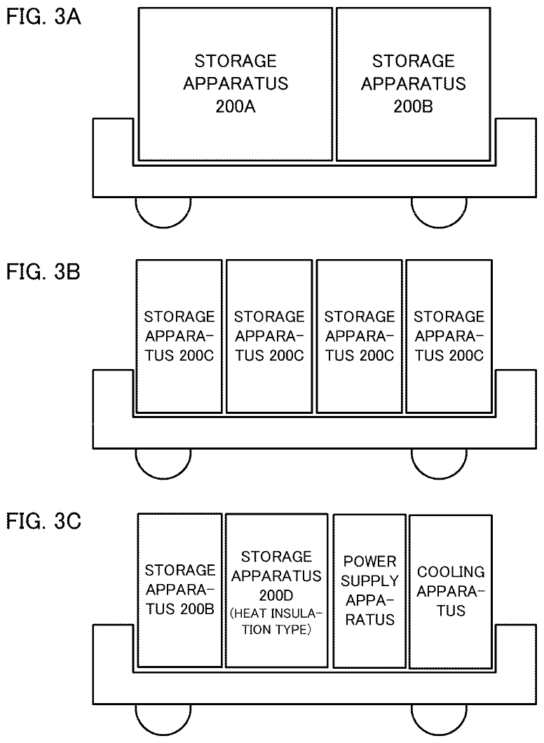

FIG. 3 is a diagram for illustrating combinations of storage apparatuses 200 loaded on one chassis unit 300.

FIG. 3(A) illustrates an example in which two storage apparatuses of different sizes are loaded on the chassis unit 300. FIG. 3(B) illustrates an example in which four storage apparatuses of the same size are loaded on the chassis unit 300. In this way, the server apparatus 100 determines the number and types of the storage apparatuses 200 loaded on the chassis unit 300 based on the number of the packages that can be contained in each apparatus and the number of the pickup sites.

Furthermore, an apparatus other than the storage apparatus 200 may be loaded on the chassis unit 300, depending on the characteristics of the packages. For example, as illustrated in FIG. 3(C), if an apparatus that cools the interior of the storage apparatus and an apparatus that supplies electricity to the cooling unit are loaded, a package can be refrigerated or frozen during transportation.

Furthermore, the server apparatus 100 issues a command to transport a storage apparatus from a delivery base to a pickup site (referred to as an operation command hereinafter) to the chassis unit 300. The operation command does not always indicate traveling. For example, the operation command may be “to unload a storage apparatus at a predetermined pickup site”, “to place a storage apparatus at a predetermined pickup site” or “to remove a storage apparatus placed at a predetermined pickup site”. That is, the operation command may include an operation other than traveling to be performed by the chassis unit 300.

The server apparatus 100, the storage apparatus 200 and the chassis unit 300 are interconnected over a network. The network may be a wide area network (WAN) that is a global public communication network, such as the Internet, or other communication networks. The network may include a telephone network for cellular phones or the like or a wireless communication network, such as Wi-Fi (registered trademark).

Next, the server apparatus 100 will be described in detail.

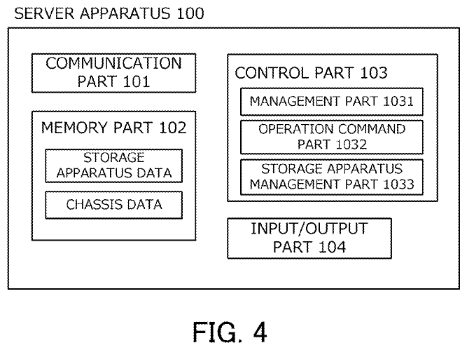

FIG. 4 is a diagram illustrating a system configuration of the server apparatus 100. The server apparatus 100 includes a communication part 101, a memory part 102, a control part 103 and an input/output part 104.

The server apparatus 100 is constituted by a common computer. Specifically, the server apparatus 100 is a computer having a processor, such as a CPU or GPU, a main memory, such as a RAM or a ROM, and an auxiliary memory, such as an EPROM, a hard disk drive or a removable medium. The removable medium may be an USB memory or a disk recording medium, such as a CD or a DVD. The auxiliary memory stores an operating system (OS), various programs, or various tables, and each of the various functions described later suitable for a predetermined purpose can be implemented by loading a program stored in the auxiliary memory into a working area of the main memory and executing the program to control each component or the like. However, some or all of the functions may be implemented by a hardware circuit, such as ASIC or FPGA. The server apparatus 100 may be constituted by a single computer or a plurality of computers associated with each other.

The communication part 101 is a communication interface that connects the server apparatus 100 to the network. The communication part 101 includes a network interface board and a wireless communication circuit for wireless communication.

The memory part 102 includes the main memory and the auxiliary memory. The main memory is a memory in which a program to be executed by the control part 103 or data to be used by the control program is deployed. The auxiliary memory is a memory that stores a program to be executed by the control part 103 or data to be used by the control program.

The memory part 102 further stores storage apparatus data and chassis data.

The storage apparatus data is data concerning the storage apparatus 200 that can be loaded on the chassis unit 300.

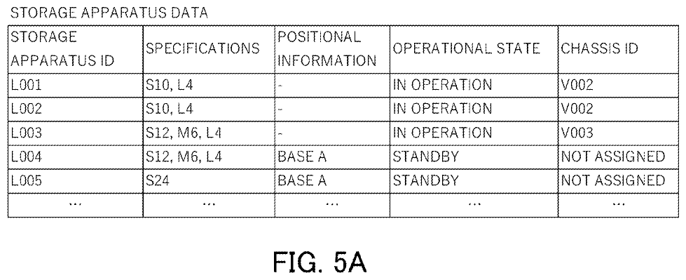

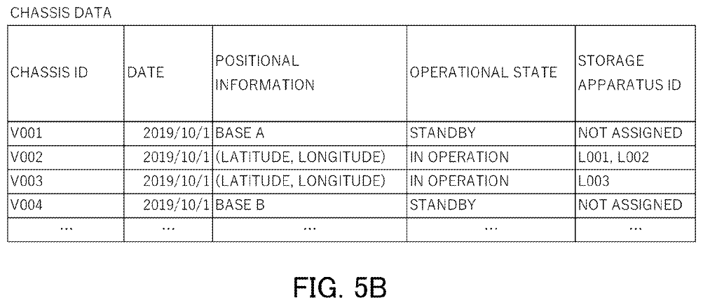

FIG. 5A illustrates an example of the storage apparatus data. The storage apparatus data is data that describes the identifier of the storage apparatus 200 managed by the server apparatus, the specifications (the number, size or capability of the compartments for housing packages) of the storage apparatus 200, the positional information on the storage apparatus 200, the operational state of the storage apparatus 200, or the identifier of the chassis unit 300 paired with the storage apparatus 200, for example.

The chassis data is data concerning the chassis unit 300.

FIG. 5B illustrates an example of the chassis data. The chassis data is data that describes the identifier of the chassis unit 300 managed by the server apparatus, the positional information on the chassis unit 300, the operational state of the chassis unit 300, or the identifier of the storage apparatus 200 loaded on the chassis unit 300, for example. The chassis data may include other information. For example, the chassis data may include information on the use, type or standby point (shed or branch office) of the chassis unit 300, or information on the door type, the vehicle size, the load capacity, the distance to empty at the time when the chassis unit is fully charged, the current distance to empty, the current load quantity, weight, volume, or the destination address.

The storage apparatus data and the chassis data are periodically updated based on information transmitted from the storage apparatus 200 and the chassis unit 300.

A database that stores these pieces of data is constructed by a program of a database management system (DBMS) executed by the processor managing the data stored in the memories. The database used in this embodiment is a relational database, for example.

The control part 103 is a computing device that is responsible for the control performed by the server apparatus 100. The control part 103 can be implemented by an arithmetic processing unit, such as a CPU.

The control part 103 has three functional modules, specifically, a management part 1031, an operation command part 1032 and a storage apparatus management part 1033. Each of the functional modules may also be implemented by the CPU executing a program stored in the auxiliary memory.

The management part 1031 collects information concerning the chassis unit 300 and the storage apparatus 200 and updates a database. Specifically, the management part 1031 periodically communicates with a plurality of chassis units 300 (storage apparatuses 200) to collect information concerning the chassis units 300 (storage apparatuses 200). The collected information is reflected in the chassis data and the storage apparatus data.

The operation command part 1032 generates a command (operation command) to operate the chassis unit 300.

The operation command includes the identifier of the storage apparatus 200 for transportation or the identifier of the location (pickup site) at which the storage apparatus 200 is to be placed, for example. The operation command may include other information. For example, the operation command may include a command “to remove a storage apparatus 200 previously placed and returns to a delivery base”.

The chassis unit 300 autonomously travels according to the operation command generated by the operation command part 1032.

The storage apparatus management part 1033 performs the two kinds of processings described below.

(1) Determination of storage apparatus(es) 200 to be loaded on chassis unit 300

As described above, the storage apparatus(es) 200 to be loaded on the chassis unit 300 varies depending on the number and sizes of the packages to be transported, and the storage apparatus management part 1033 selects an appropriate apparatus depending on the packages to be transported.

(2) Management of information required to unlock compartment of storage apparatus 200

The storage apparatus management part 1033 manages lock information required when the recipient picks up a package.

Specifically, the storage apparatus management part 1033 generates first authentication information to be retained by the storage apparatus 200 and second authentication information to be retained by the recipient. In this embodiment, the storage apparatus 200 is configured so that each compartment can be locked with an electronic lock, and when the first authentication information stored in the storage apparatus 200 and the second authentication information obtained from the recipient match with each other, the relevant compartment is unlocked. To this end, the storage apparatus management part 1033 generates the first authentication information and the second authentication information in such a manner that the two pieces of information match with each other.

The second authentication information may be a combination number or a two-dimensional barcode, for example. When a short-range wireless communication can be established between a terminal of the recipient and the storage apparatus 200, the second authentication information may be information that can be wirelessly transmitted.

The method of the authentication performed by the storage apparatus 200 may be a method of simply comparing the two pieces of authentication information to verify the matching therebetween, or a method of using an encryption key (such as challenge-response authentication). Other well-known techniques can also be used.

The first authentication information is stored in the memory part 203 when the package is contained in the storage apparatus 200. The second authentication information is transmitted to the terminal of the recipient when the storage apparatus 200 arrives at a predetermined pickup site.

The input/output part 104 is an interface that presents information to a user of the system (typically, a staff member of the package transport company and the like, which will be referred to simply as a staff member), and obtains information. The input/output part 104 is constituted by a display device or a touch panel, for example. The input/output part 104 may have a unit that transmits data to and receives data from another apparatus.

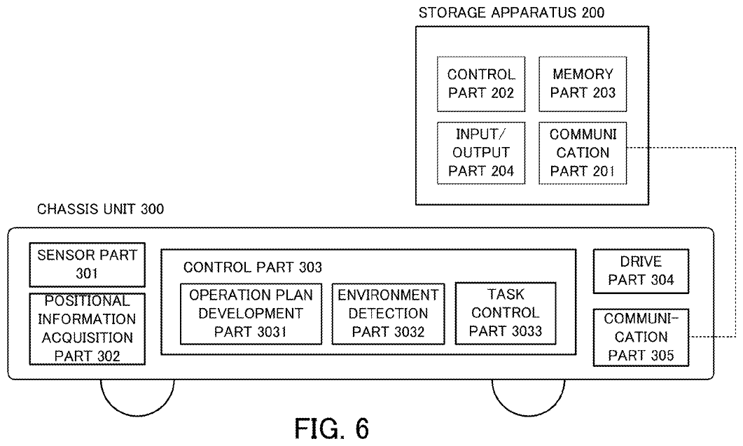

Next, the storage apparatus 200 will be described with reference to FIG. 6.

The storage apparatus 200 is a locker-type apparatus (parcel box) that has a plurality of compartments and can contain a package in each compartment. As described above with reference to FIG. 2, the storage apparatus 200 is configured so that each separate compartment can be accessed by opening a door.

The storage apparatus 200 includes a communication part 201, a control part 202, a memory part 203 and an input/output part 204. The storage apparatus 200 operates on the electricity supplied from a battery.

The communication part 201 is a communication interface that communicates with the server apparatus 100 via a network, as with the communication part 101.

The control part 202 is a computer that controls the locking and unlocking of the plurality of compartments. The control part 202 is constituted by a microcomputer, for example. The control part 202 may be implemented by a central processing unit (CPU) executing a program stored in a memory unit, such as a read only memory (ROM).

The control part 202 checks the authentication information obtained from the recipient via the input/output part 204 described later against the authentication information previously stored in the memory part 203 described later. If the two pieces of authentication information match with each other, the control part 202 performs a control to unlock the electronic lock of the relevant compartment.

The control part 202 also periodically notifies the server apparatus 100 of the status of the storage apparatus 200 (such as whether the storage apparatus 200 is moving, whether the storage apparatus 200 has arrived at the pickup site, the current positional information, the identifier of the chassis unit paired with the storage apparatus 200). The server apparatus 100 (management part 1031) updates the storage apparatus data based on the notified information.

The memory part 203 is a unit that stores information and is constituted by a memory medium, such as a RAM, a magnetic disk or a flash memory. The memory part 203 stores authentication information required for checking when the package is passed to the recipient.

The input/output part 204 is an interface on which information is presented to the recipient and authentication information is obtained from the recipient. The input/output part 204 is constituted by a display device or a touch panel, for example. The input/output part 204 may have another unit configured to obtain authentication information. For example, the input/output part 204 may include a camera that reads a two-dimensional barcode, or a short-range communication unit for wireless transmission, for example.

Although the storage apparatus 200 illustrated in FIG. 2 is a stationary type, the storage apparatus 200 may further have a unit for autonomous movement. For example, the storage apparatus 200 may further have a drive part, such as a wheel, and a control part that controls the drive part. With such a configuration, the storage apparatus 200 can autonomously place itself at a predetermined location after the storage apparatus 200 is unloaded from the chassis unit 300.

Furthermore, the storage apparatus 200 may include a unit for fixing the storage apparatus 200. For example, if the storage apparatus 200 is connected to an anchor, a rail or the like fixed to the road surface or a building, the storage apparatus can be prevented from being stolen.

The chassis unit 300 is a vehicle platform that travels according to an operation command obtained from the server apparatus 100. More specifically, the chassis unit 300 generates a travel route based on an operation command obtained by wireless communication and travels on the road in an appropriate manner while sensing the surroundings of the vehicle.

The chassis unit 300 includes a sensor part 301, a positional information acquisition part 302, a control part 303, a drive part 304 and a communication part 305. The chassis unit 300 operates on the electricity supplied from a battery.

The sensor part 301 is a unit that senses the surroundings of the vehicle and typically includes a stereo camera, a laser scanner, a LIDAR or a radar, for example. Information obtained by the sensor part 301 is transmitted to the control part 303. The sensor part 301 includes a sensor for enabling autonomous traveling.

The sensor part 301 may include a camera provided on the chassis unit 300. For example, the sensor part 301 may include a picture-taking device using an image sensor, such as a charge-coupled device (CCD) image sensor, a metal-oxide-semiconductor (MOS) image sensor or a complementary metal-oxide-semiconductor (CMOS) image sensor.

The positional information acquisition part 302 is a unit that acquires the current location of the chassis unit 300 and typically includes a GPS receiver. Information acquired by the positional information acquisition part 302 is transmitted to the control part 303.

The control part 303 is a computer that controls the chassis unit 300 based on the information obtained from the sensor part 301. The control part 303 is constituted by a microcomputer, for example.

The control part 303 has an operation plan development part 3031, an environment detection part 3032 and a task control part 3033 as functional modules. Each of the functional modules may be implemented by a central processing unit (CPU) executing a program stored in a memory unit, such as a read only memory (ROM).

The operation plan development part 3031 obtains an operation command from the server apparatus 100 and develops an operation plan. In this embodiment, the operation plan is data that prescribes a travel route and a procedure to be performed at a part or all of the route.

The travel route can be automatically generated based on a given point of departure and a given point of destination by referring to map data stored in advance.

The procedure to be performed on the route may be “to unload the storage apparatus 200” or “to remove the storage apparatus 200”, for example. However, the procedure is not limited to these procedures. For example, the procedure may be “to transmit a notification to a staff member of the shop in which the storage apparatus 200 is to be placed in order to place the unloaded storage apparatus 200 at a predetermined location”.

The operation plan developed by the operation plan development part 3031 is transmitted to the task control part 3033 described later.

The environment detection part 3032 detects the environment surrounding the vehicle based on the data from the sensor part 301. What is detected may be the number and positions of the lanes, the number and positions of the vehicles around the vehicle, the number and positions of the obstacles (such as pedestrians, bicycles, structures or buildings) around the vehicle, the configuration of the road or traffic signs, without limitation. Anything required to enable the autonomous traveling can be detected.

Furthermore, the environment detection part 3032 may track a detected object. For example, the relative velocity of the object may be determined from the difference between the current coordinates of the object and the coordinates of the object detected in the previous step.

The data concerning the environment (referred to as environmental data hereinafter) generated by the environment detection part 3032 is transmitted to the task control part 3033 described below.

The task control part 3033 controls the traveling of the vehicle based on the operation plan developed by the operation plan development part 3031, the environmental data generated by the environment detection part 3032 and the positional information on the vehicle obtained by the positional information acquisition part 302. For example, the task control part 3033 makes the vehicle travel along a predetermined route in such a manner that any obstacle does not enter a predetermined safety zone centered at the vehicle. The method of making the vehicle autonomously travel can be a well-known method.

The task control part 3033 can also make the storage apparatus 200 perform a task other than traveling (such as unloading, placement or removal of the storage apparatus 200) based on the operation plan developed by the operation plan development part 3031 (and the environmental data generated by the environment detection part 3032, the positional information on the vehicle obtained by the positional information acquisition part 302 or the like, as required).

The drive part 304 is a unit that makes the chassis unit 300 travel based on a command generated by the task control part 3033. The drive part 304 includes a motor for driving a wheel, an inverter, a brake, a steering mechanism and a secondary battery, for example.

The communication part 305 is a communication unit that connects the chassis unit 300 to the network. In this embodiment, the communication part 305 can communicate with another apparatus (for example, the server apparatus 100) over a network using a mobile communication service, such as 3G, LTE or 5G.

The communication part 305 may further has a communication unit for inter-vehicle communication with another vehicle.

The storage apparatus 200 can be loaded in the cabin or on the bed of chassis unit 300. The chassis unit 300 can also be configured so that a plurality of storage apparatuses 200 can be loaded. The chassis unit 300 can also be provided with a mechanism (including an elevator, an actuator and a guide rail) that lifts and lowers only a predetermined storage apparatus 200 of a plurality of storage apparatuses 200.

These components are controlled by the task control part 3033.

The chassis unit 300 periodically notifies the server apparatus 100 of the status of the chassis unit 300 (such as the positional information or the identifier of the storage apparatus loaded thereon, which will be referred to as vehicle information hereinafter). The server apparatus 100 (management part 1031) updates the chassis data based on the notified information. The chassis unit 300 may transmit other information, such as the information illustrated below, as the vehicle information to the server apparatus 100.

Information on the transportation capacity (such as the number, size, weight of the storage apparatuses that can be loaded).

The identifier(s) of the storage apparatus(es) currently loaded.

The capacity of the storage apparatus(es) currently loaded.

The weight of the storage apparatus(es) currently loaded.

The current state of charge (SOC).

The distance to empty.

Information concerning the operation route (in the case where the vehicle is in operation).

Information on the event that has occurred (such as placement or removal of a storage apparatus).

Next, a method of transporting a package using a storage apparatus will be described.

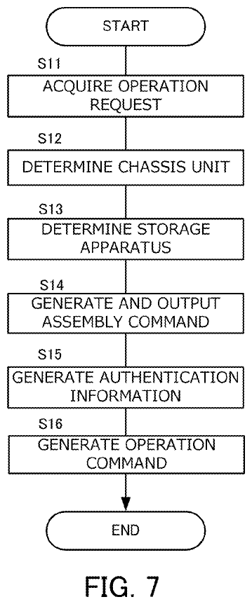

FIG. 7 is a flowchart illustrating a process of the server apparatus 100 generating an operation command based on an operation request from a staff member of a delivery company.

When a staff member of a delivery company inputs an operation request to the server apparatus 100 (Step S11), the server apparatus 100 starts generating an operation command in response to the request.

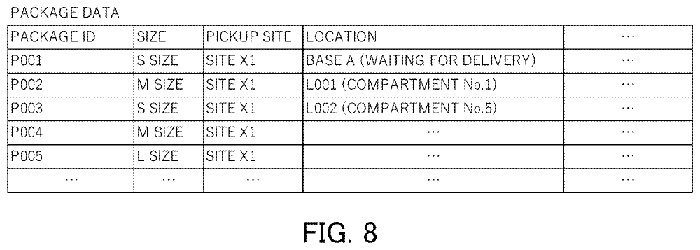

The operation request includes data concerning a package to be transported (referred to as package data hereinafter). FIG. 8 illustrates an example of the package data. The package data includes an ID that uniquely identifies the package, or information on the size of the package or the specified pickup site, for example.

In Step S12, the operation command part 1032 selects a chassis unit 300 to provide a service. For example, the operation command part 1032 refers to the stored positional information and operational state of the chassis units 300 to select a chassis unit 300 that can provide a service.

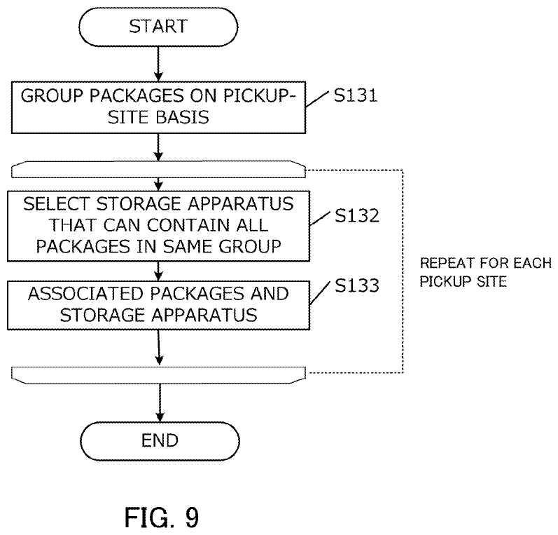

In Step S13, the storage apparatus management part 1033 then determines a storage apparatus 200 to be loaded on the chassis unit 300. FIG. 9 is a flowchart illustrating processings performed in Step S13 in detail.

First, in Step S131, a plurality of packages to be transported is grouped on a pickup-site basis. For example, if the packages to be transported are destined for two pickup sites X1 and X2, the packages are divided into two groups.

The processings of Steps S132 and S133 are performed for each pickup site (group).

In Step S132, a storage apparatus 200 that can contain all the packages of one group is selected. Whether a storage apparatus can contain the packages or not can be determined by referring to the specifications of the storage apparatus recorded in a storage apparatus database. Whether the storage apparatus 200 is available or not can be determined by referring to the operational state of and the positional information on the storage apparatus recorded in the storage apparatus database.

In Step S133, the packages and the storage apparatus 200 are associated with each other. In this step, a particular package and a particular compartment of the storage apparatus 200 are associated with each other. The association is reflected in the package data and stored.

The description of the process illustrated in FIG. 7 will be resumed.

In Step S14, the storage apparatus management part 1033 generates and outputs a command (referred to as an assembly command hereinafter) to load the storage apparatus(es) 200 on the chassis unit 300. The assembly command includes the identifier of the determined chassis unit 300, the identifier(s) of the storage apparatus(es) 200 to be loaded on the chassis unit 300, and the identifier(s) of the package(s) to be contained in the storage apparatus(es) 200, for example.

Based on the generated assembly command, the storage apparatus(es) 200 is loaded on the chassis unit 300. The method of loading the storage apparatus(es) 200 on the chassis unit 300 may be a method using a dedicated elevator or a method using an accessory mechanism of the chassis unit 300 or the storage apparatus(es) 200, for example. The method is not limited to any particular method as far as the storage apparatus(es) 200 can be lifted and lowered. If the storage apparatus(es) 200 is loaded by man power, the assembly command may be a command to a worker.

The packages to be transported are contained in the respective compartments of the storage apparatus 200 at this stage. The packages can be contained based on the package data.

In Step S15, the storage apparatus management part 1033 generates the first authentication information and the second authentication information and transmits the first authentication information to the storage apparatus 200. The first authentication information may be transmitted by wireless communication or input on the input/output part 204.

The second authentication information is transmitted to the terminal of the recipient when the placement of the storage apparatus 200 is completed.

In Step S16, the operation command part 1032 generates an operation command. Specifically, the operation command part 1032 generates an operation command “to go to the pickup site associated with the loaded storage apparatus 200 and unload the storage apparatus 200 at the pickup site” and transmits the operation command to the chassis unit 300.

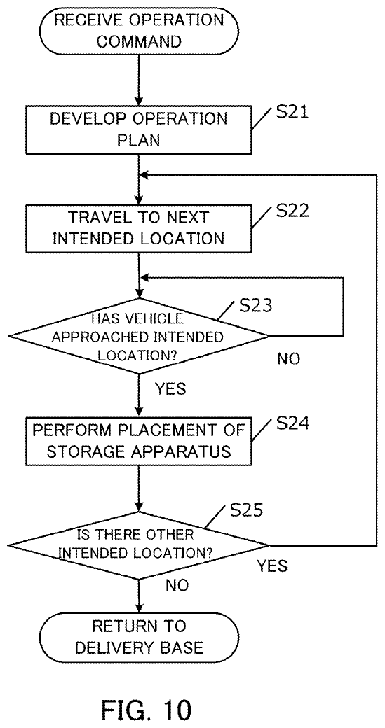

FIG. 10 is a flowchart illustrating a process performed by the chassis unit 300 in response to receiving the operation command.

In Step S21, the chassis unit 300 (operation plan development part 3031) develops an operation plan based on the received operation command. For example, the operation plan development part 3031 develops an operation plan including a task of identifying a travel route (and a pickup site) and moving to the pickup site, a task of unloading a storage apparatus 200 at the pickup site, and a task of returning to a predetermined location (such as a delivery base).

In Step S22, the task control part 3033 makes the vehicle start traveling to an intended location based on the developed operation plan. The intended location is the pickup site at which a storage apparatus 200 is to be placed next. Note that, during operation, the vehicle information is periodically transmitted to the server apparatus 100.

As the vehicle approaches the intended location (Step S23), the task control part 3033 searches for a place where the vehicle can be parked nearby the location and parks the vehicle at the place, and the storage apparatus 200 is placed (Step S24). The placement of the storage apparatus 200 may be performed automatically or by man power. For example, if the intended location is a commercial facility or the like, a message may be transmitted to a mobile terminal of a staff member of the shop to call the staff member to place the storage apparatus 200. Alternatively, the storage apparatus 200 may be provided with a unit for autonomous movement so that the storage apparatus 200 can automatically moves from the chassis unit 300.

Once the storage apparatus 200 is placed, information indicating the placement is transmitted from the chassis unit 300 to the server apparatus 100 as the vehicle information. In this embodiment, in response to this, the server apparatus 100 (storage apparatus management part 1033) identifies the recipient associated with the placed storage apparatus 200 (that is, the person who will receive the package contained in the storage apparatus 200) and transmits the associated second authentication information to the terminal of the recipient. To this end, the server apparatus 100 may be configured to be able to obtain information for identifying the terminal of the recipient (such as an application-specific ID, email address or the like).

The task control part 3033 then determines whether or not there is another intended location based on the operation plan (Step S25), and continues the operation if there is another intended location. If there is no other intended location, the vehicle returns to the delivery base.

When the recipient comes to the storage apparatus 200 placed at a predetermined location, the control part 202 of the storage apparatus 200 acquires the second authentication information via the input/output part 204 and checks the second authentication information against the first authentication information stored in the memory part 203. The second authentication information may be acquired as character data via a keyboard or a touch panel, or acquired as image data via a camera or a scanner. Alternatively, the second authentication information may be acquired via wireless communication.

If it is confirmed that the two pieces of information match with each other, the control part 202 unlocks the relevant compartment. Then, the recipient can pick up the package. When the package is picked up, the control part 202 notifies, via the communication part 201, the storage apparatus management part 1033 of the server apparatus 100 that the package has been picked up. Then, the storage apparatus management part 1033 can grasp the status of package pickup of each storage apparatus 200.

If there is a package that has not been picked up from the storage apparatus 200 after a lapse of a predetermined time, the storage apparatus management part 1033 may be configured to transmit a reminder to the terminal of the relevant recipient.

As described above, according to the first embodiment, in the system that delivers a package on the chassis unit 300, a parcel locker itself can be transported and placed at a predetermined location. In this way, the convenience of the recipient can be improved, and the redelivery cost can be reduced. Furthermore, since a storage apparatus 200 of a type suitable for the characteristics of the package to be delivered can be selected, so that waste can be reduced.

If the status of pickup of packages from a storage apparatus 200 satisfies a predetermined condition, the server apparatus 100 may generate an operation command to remove the storage apparatus 200 and transmit the operation command to an arbitrary chassis unit 300. In that case, the chassis unit 300 removes the storage apparatus 200 according to the operation command. The predetermined condition may be that “a predetermined time has elapsed since the storage apparatus 200 was placed” or “a predetermined number of packages have been picked up from the storage apparatus 200”, for example.

### Second Embodiment

In the first embodiment, the storage apparatus 200 serving as a normal parcel locker has been illustrated. To the contrary, a second embodiment concerns transportation of a parcel locker having a refrigeration or freezing capability.

As shown in FIG. 3(C), if a storage apparatus 200 having a heat insulation capability, a cooling apparatus and a power supply apparatus are combined and placed, a parcel locker having a heat insulation capability can be provided.

In the second embodiment, information concerning whether heat insulation (room temperature, refrigeration or freezing) is required or not is added to the package data. In addition, in Step S13, the storage apparatus 200 is selected based on whether heat insulation is required or not. For example, if the packages to be transported includes a package that requires heat insulation, the storage apparatus management part 1033 selects a storage apparatus 200 that has a compartment having a heat insulation capability, a power supply apparatus and a cooling apparatus, and generates an assembly command to load these apparatuses on the chassis unit 300. In this step, the required cooling capacity may be calculated from the number or size of the compartments that require heat insulation to select a cooling apparatus and a power supply apparatus of an appropriate type.

Note that all the compartments of the storage apparatus 200 used in the second embodiment do not have to have a heat insulation capability. For example, some of the compartments may have a heat insulation capability. In that case, the storage apparatus 200 to be loaded is selected based on the number (size) of the packages that require heat insulation and the number (size) of the compartments that have a heat insulation capability.

(Modifications)

The embodiments described above are just examples, and various modifications are possible without departing from the spirit of the present disclosure.

For example, the processings and units described in the present disclosure can be used in any combination as far as no technical contradiction occurs.

Although the number and types of the storage apparatus 200 to be loaded on the chassis unit 300 are determined in the embodiments described above, if space permits, any unit that is irrelevant to the delivery of the package (such as a cabin unit) can be loaded to make good use of space.

Although the server apparatus 100 generates the operation command of the chassis unit 300 in the embodiments described above, there may be separately provided an apparatus that generates the operation command and an apparatus that generates the assembly command.

Although the chassis unit 300 has been illustrated in the embodiments described above, the delivery system according to the embodiments can also be applied to any conveyance other than the vehicle. For example, by loading a storage apparatus on an aircraft platform (such as a drone) or a ship platform, an aircraft or ship used for transportation can be assembled.

In the description of the embodiments, the storage apparatuses 200 are arranged side by side in the horizontal direction. However, the storage apparatus 200 may be stacked on one another in the vertical direction. In that case, the order in which the storage apparatuses 200 are stacked can be determined based on the order in which the storage apparatus 200 are placed. Alternatively, the order in which the storage apparatuses 200 are stacked may be determined so that the center of gravity thereof is as low as possible based on the weight of the packages.

In description of the embodiments, an example has been described in which the storage apparatus 200 is separated from the chassis unit 300 at the pickup site. However, the storage apparatus 200 may not be separated from the chassis unit 300 but may serve as a parcel locker on the vehicle parked there.

Furthermore, a processing described as being performed by one device may be performed in cooperation of a plurality of devices. Alternatively, processings described as being performed by different devices may be performed by one device. In the computer system, the hardware component (server component) that provides each function can be flexibly changed.

The present disclosure can also be implemented by installing a computer program that implements the functions described above with regard to the embodiments in a computer and by one or more processors of the computer reading and executing the program. Such a computer program may be provided to the computer via a non-temporary computer readable memory medium that can be connected to a system bus of the computer, or may be provided to the computer via a network. The non-temporary computer readable memory medium may be any type of disk such as a magnetic disk (such as a floppy (registered trademark) disk or a hard disk drive (HDD)) or an optical disk (such as a CD-ROM, a DVD disk or a Blu-ray disk), or any type of medium suitable for storage of an electronic instruction, such as a read only memory (ROM), a random access memory (RAM), an EPROM, an EEPROM, a magnetic card, a flash memory or an optical card.

What is claimed is:

1. An information processing apparatus comprising a controller configured to
acquire package information, which is information on a size of one or more packages to be transported,
select, based on the package information, a storage apparatus to be loaded on a vehicle from among a plurality of storage apparatuses having different characteristics that is capable of containing the one or more packages in a plurality of compartments that is capable of being independently locked, and
generate a command to load the selected storage apparatus on the vehicle.

2. The information processing apparatus according to claim 1, wherein
the vehicle is a vehicle that transports the storage apparatus to a predetermined site at which a recipient picks up a package.

3. The information processing apparatus according to claim 2, wherein
the controller performs the selection on an assumption that a plurality of packages destined for a same site is contained in a same storage apparatus.

4. The information processing apparatus according to claim 2, further comprising
a storage unit that stores information indicating a size of the plurality of compartments of the plurality of storage apparatuses.

5. The information processing apparatus according to claim 4, wherein
the controller selects a storage apparatus capable of containing all of a plurality of packages destined for a same site based on the package information.

6. The information processing apparatus according to claim 2, wherein
the controller selects a storage apparatus for each specified site.

7. The information processing apparatus according to claim 1, wherein
the package information further includes key information for unlocking the plurality of compartments, and
the controller transmits the key information to the storage apparatus.

8. The information processing apparatus according to claim 1, wherein
the controller collects information concerning a status of pickup of a package from the plurality of storage apparatuses.

9. The information processing apparatus according to claim 1, wherein
the controller further generates a command to unload the storage apparatus from the vehicle at a relevant site.

10. An information processing method comprising:
an acquisition step of acquiring package information, which is information on a size of one or more packages to be transported;
a selection step of selecting, based on the package information, a storage apparatus to be loaded on a vehicle from among a plurality of storage apparatuses having different characteristics that is capable of containing the one or more packages in a plurality of compartments that is capable of being independently locked; and
a generation step of generating a command to load the selected storage apparatus on the vehicle.

11. The information processing method according to claim 10, wherein
the vehicle is a vehicle that transports the storage apparatus to a predetermined site at which a recipient picks up a package.

12. The information processing method according to claim 11, wherein
in the selection step, the selection is performed on an assumption that a plurality of packages destined for a same site is contained in a same storage apparatus.

13. The information processing method according to claim 11, wherein
in the acquisition step, information indicating a size of the plurality of compartments of the plurality of storage apparatuses is further acquired.

14. The information processing method according to claim 13, wherein
in the selection step, a storage apparatus capable of containing all of a plurality of packages destined for a same site is selected based on the package information.

15. The information processing method according to claim 11, wherein
in the selection step, a storage apparatus is selected for each specified site.

16. The information processing method according to claim 10, wherein
the package information further includes key information for unlocking the plurality of compartments, and the key information is transmitted to the storage apparatus.

17. The information processing method according to claim 10, wherein
information concerning a status of pickup of a package is collected from the plurality of storage apparatuses.

18. The information processing method according to claim 10, wherein
a command to unload the storage apparatus from the vehicle at a relevant site is generated.

19. A non-transitory computer readable storing medium recording a computer program for causing a computer to perform an information processing method comprising:
an acquisition step of acquiring package information, which is information on a size of one or more packages to be transported;
a selection step of selecting, based on the package information, a storage apparatus to be loaded on a vehicle from among a plurality of storage apparatuses having different characteristics that is capable of containing the one or more packages in a plurality of compartments that is capable of being independently locked; and
a generation step of generating a command to load the selected storage apparatus on the vehicle.
